(19) United States
(12) Patent Application Publication
(10) Pub. No.: US 2008/0059568 A1
(43) Pub. Date: Mar. 6, 2008

(54) Communication system

(75) Inventor: Kazuyuki Takagi, Chiba (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/822,212

(22) Filed: Jul. 3, 2007

(30) Foreign Application Priority Data
Aug. 30, 2006 (JP) JP2006-233581

(51) Int. Cl. G06F 15/16

(52) U.S. Cl. 709/203

(57) ABSTRACT

A communication system is provided capable of using the existing web server just as it is and displaying presence information on web scene. In the communication system comprising a web server; a terminal apparatus having web browser function; a plurality of communication terminals having terminal identification information; and a communication server having a presence information storing section, the terminal apparatus includes a displaying and obtaining section which obtains the displayed terminal identification information, an inputting section which inputs a presence request, and a sending section which sends the presence request and the terminal identification information to the communication server; the communication server includes a server receiving section to receive the presence request and the terminal identification information, an indexing and reading section which indexes the presence information storing section and reads out the corresponding presence information, a web scene generating section which generates a web scene serving as web presence scene, and a server sending section which send web presence scene information of the web presence scene to the terminal apparatus.

### FIELD OF THE INVENTION

The invention relates to a communication system to execute presence service, specially relates to a communication system capable of displaying presence information on web scene.

### RELATED BACKGROUND ART

On the one hand, web page business system is constituted by a web server and a plurality of terminal apparatuses that can communicate with the web server and respectively have web browser function. The web page business system is introduced to office environment and the like. For example, in web scene displayed on the respective terminal apparatuses, through inputting and referring to business information, product stock information, schedule information of respective users, address information, and various information used by users in common, the web page business system support the business in office, that is, web page business.

On the other hand, in recent years, communication service capable of executing exchange of letter information, image information, voice information or the like among the plurality of terminal apparatuses via SIP (Session Initiation Protocol) server is also introduced to and is used in the above-stated office environment. The communication service is provided in a communication system that includes SIP server and a plurality of terminal apparatuses in which communication application for communication service is installed, and for example, is used in telephone communication from one terminal apparatus to another terminal apparatus and the like.

Further, as another service provided in the above-stated communication system, a presence service capable of displaying presence information on communication scene of respective terminal apparatuses is known. Here, the presence information is information to express a state of terminal apparatus or user of the terminal apparatus. The SIP server obtains the presence information indicating whether the terminal apparatus is in communicating or not, or, whether the user of the terminal apparatus is in operation or not, or the like from respective terminal apparatuses; and manages the presence information. The SIP server, when received a presence request expressing to request presence information from any terminal apparatus, reads out a list of the managed presence information and sends it to the terminal apparatus. The terminal apparatus, in order to display the list of the presence information received from the SIP server, generates a communication scene and displays the communication scene.

In the case that the presence information of other terminal apparatus becomes necessary while the terminal apparatus capable of using the above-stated presence service is executing a web page business using web scene, the user of the terminal apparatus first performs operations for starting communication application, and makes a display change from the web scene to a communication scene. Then, when the communication scene is displayed on an apparatus displaying section, the user selects an input button in the communication scene for inputting a presence request. The terminal apparatus accepts the selection operation and sends the inputted presence request to the SIP server. Then, when a list of the presence information is sent from the SIP server to the terminal apparatus, the list is displayed on the communication scene of the terminal apparatus.

However, in order to confirm the presence information corresponding to a desired terminal apparatus in the communication scene, the user must index the presence information. Further, after confirmed the presence information, in order to continue the web page business, the user has to make the display change from the communication scene to the web scene, so that a lot of time and labor are needed. Furthermore, in the case to need the presence information of plural terminal apparatuses, the user has to perform the index and the scene change work many times, therefore it is very troublesome for the user.

Further, conventionally, the SIP server has no such function to generate web scene. Because of it, while executing the web page business, it is necessary to display the presence information on the same web scene without changing the web scene into the communication scene. However, with respect to the existing web server, in order to make it realize such presence service function, complex developing and revising works become necessary. Furthermore, in the web server, plural application programs are contained, and the above-stated developing and revising works are needed with respect to each application program, therefore, in order to realize the display of the above-stated presence information, there is a problem that many time and high cost need to spend.

Thereby, a communication system capable of using the existing web server just as it is, and displaying the presence information on the web scene is desired.

### SUMMARY OF THE INVENTION

It is, therefore, an object of the invention to provide an communication system capable of solving the above problem.

According to the present invention, there is provided an communication system, comprising:
a web server which stores web scene;
a terminal apparatus which enables to communicate with the web server;
a plurality of communication terminals each has terminal identification information; and
a communication server which has a presence information storing section which enables to communicate with the terminal apparatus and the communication terminal, and stores presence information indicating a state of the communication terminal or a state of user of the communication terminal to correspond to the terminal identification information of the communication terminal,
wherein the web server has web scene in which the terminal identification information is stated;
the terminal apparatus includes a displaying and obtaining section which displays the web scene and obtains the displayed terminal identification information, an inputting section which inputs a presence request expressing to request the presence information corresponding to the obtained terminal identification information, and a sending section which sends the inputted presence request and the obtained terminal identification information to the communication server;
the communication server includes a server receiving section to receive the presence request and the terminal identification information from the terminal apparatus, an indexing and reading section which indexes the presence information storing section on the basis of the received terminal identification information and reads out the corresponding presence information, a web scene generating section which generates a web scene serving as web presence scene for displaying the presence information read out, and a server sending section which send web presence scene information of the web presence scene to the terminal apparatus.

Moreover, in the communication system, the terminal apparatus further includes a starting section which starts communication application for requesting the presence information with respect to the communication server, together with an input of the inputting section, and the sending section performs a sending operation together with a start of the starting section.

Moreover, in the communication system, the displaying and obtaining section further displays the web presence scene together with the web scene, on the basis of the web presence scene information received from the communication server.

Moreover, in the communication system, the terminal apparatus further includes a display controlling section which makes the displaying and obtaining section display a request selection menu scene for making user of the terminal apparatus select whether to request the presence information or not, and the inputting section performs an input of the presence request on the basis of a request selection.

Moreover, in the communication system, the displaying and obtaining section obtains web scene information of the displayed web scene; the sending section further sends the obtained web scene information to the communication server; the communication server further includes an abstracting section which abstracts the terminal identification information from the web scene information received from the terminal apparatus; and the indexing and reading section performs an indexing and reading operation on the basis of the abstracted terminal identification information.

Moreover, in the communication system, the web scene information may be formed from HMTL source of the web scene.

Moreover, in the communication, the web presence scene information may be formed from HMTL source of the web presence scene.

Moreover in the communication system, the terminal identification information may be communication number of the communication terminal, which is formed from plural numerals.

Moreover, in the communication system, the terminal identification information may be is communication address of the communication terminal, which is formed from plural English letters and symbols.

Moreover, in the communication system, the terminal identification information may be email address of the communication terminal.

Moreover, in the communication system, the terminal identification information may be user name of user of the communication terminal.

Moreover, in the communication system, the communication server may be a SIP server executing communication by using SIP signal, the terminal apparatus and communication terminal may be a personal computer capable of respectively communicating with the SIP server via IP network, the terminal identification information may be a SIP address of the personal computer.

Moreover, in the communication system, the communication server may be a SIP server executing communication by using SIP signal, the terminal apparatus and communication terminal ma be a portable telephone apparatus capable of respectively communicating with the SIP server via IP network, the terminal identification information may be telephone number of the portable telephone apparatus.

Moreover, in the communication system, the communication server may be a SIP server executing communication by using SIP signal, the terminal apparatus and communication terminal may be a portable information terminal (PDA) capable of respectively communicating with the SIP server via IP network, the terminal identification information may be SIP address of the portable information terminal.

Moreover, in the communication system, the communication server may be a SIP server executing communication by using SIP signal, the communication terminal may be a telephone apparatus capable of communicating with the SIP server via telephone line network, the terminal identification information may be telephone number of the telephone apparatus.

Moreover, in the communication system, the communication server may be a SIP server executing communication by using SIP signal, the terminal apparatus may consist of a telephone apparatus capable of communicating with the SIP server via telephone line network and a communication terminal capable of communicating with the web server via internet.

The effect of the present invention:

According to the communication system of the present invention, a web scene generating section to generate a web scene for display presence information is furnished in the SIP server; and in the terminal apparatus which is displaying a web scene and is executing web page business, the presence information of other terminal apparatus can be displayed on the same web scene. Therefore, it is unnecessary to perform the troublesome operation of scene change. So that service performance to the user is improved. Further, because the existing web server can be used just as it is, it is possible to provide a cheap communication system capable of executing web page business effectively and speedily.

The above and other objects and features of the present invention will become apparent from the following detailed description and the appended claims with reference to the accompanying drawings.

### BRIEF DESCRIPTION OF THE DRAWINGS

FIG. 1 is a block diagram showing a structure of a part of a communication system in embodiment 1 of the present invention;

FIG. 2 is a block diagram showing a structure of a communication system in embodiment 1 of the present invention;

FIG. 3 is an explanation diagram showing a structure of a presence information storing section in embodiment 1;

FIG. 4 is a flowchart to explain operations of a communication system in embodiment 1 of the present invention;

FIG. 5A is an explanation diagram of a first web scene in an example displayed on a displaying section in embodiment 1;

FIG. 5B is an explanation diagram of a second web scene in an example displayed on a displaying section in embodiment 1;

FIG. 5C is an explanation diagram of a third web scene in an example displayed on a displaying section in embodiment 1;

FIG. 6 is a block diagram showing a structure of a part of a communication system in embodiment 2 of the present invention;

FIG. 7 is an explanation diagram showing a structure of a presence information storing section in embodiment 2;

FIG. 8 is a flowchart to explain operations of a communication system in embodiment 2 of the present invention;

FIG. 9A is an explanation diagram of a first web scene in an example displayed on a displaying section in embodiment 2;

FIG. 9B is an explanation diagram of a second web scene in an example displayed on a displaying section in embodiment 2;

FIG. 9C is an explanation diagram of a third web scene in an example displayed on a displaying section in embodiment 2; and

FIG. 10 is an explanation diagram showing an example of web scene information.

### DETAILED DESCRIPTION OF THE PREFERRED EMBODIMENTS

Embodiments of the invention will be described in detail hereinbelow with reference to the drawings.

### Embodiment b 1

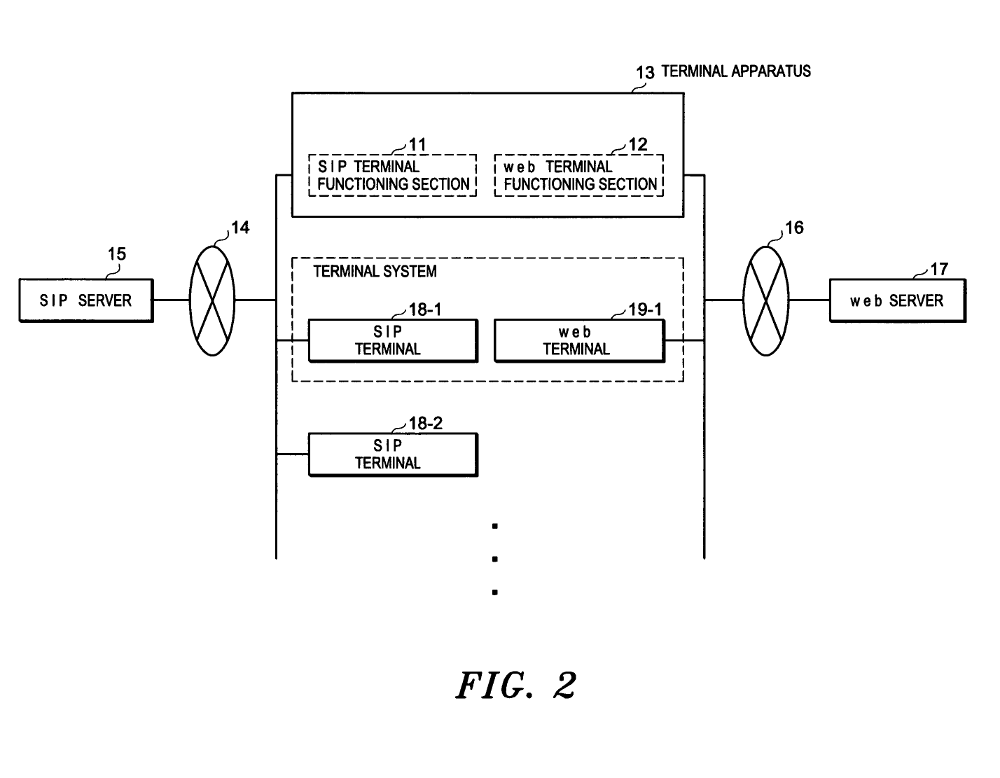

FIG. 2 is a block diagram showing a structure of a communication system in embodiment 1 of the present invention.

A communication system 10 of the present invention, as shown by FIG. 2, comprises a terminal apparatus 13 including a SIP terminal functioning section 11 and a web terminal functioning section 12; a SIP (Session Initiation Protocol) server 15 capable of communicating with the SIP terminal functioning section 11 of the terminal apparatus 13 via an IP network 14; a web server 17 capable of communicating with the web terminal functioning section 12 of the terminal apparatus 13 via an internet 16. The communication system 10 further comprises a plurality of terminal apparatuses such as SIP terminal 18 or web terminal 19 or the like. In the communication system 10, not only letter information, image information, voice information or the like can be exchanged between the respective SIP terminals 18 and the terminal apparatus 13, but also web page business can be executed between the respective web terminals 19 and the terminal apparatus 13.

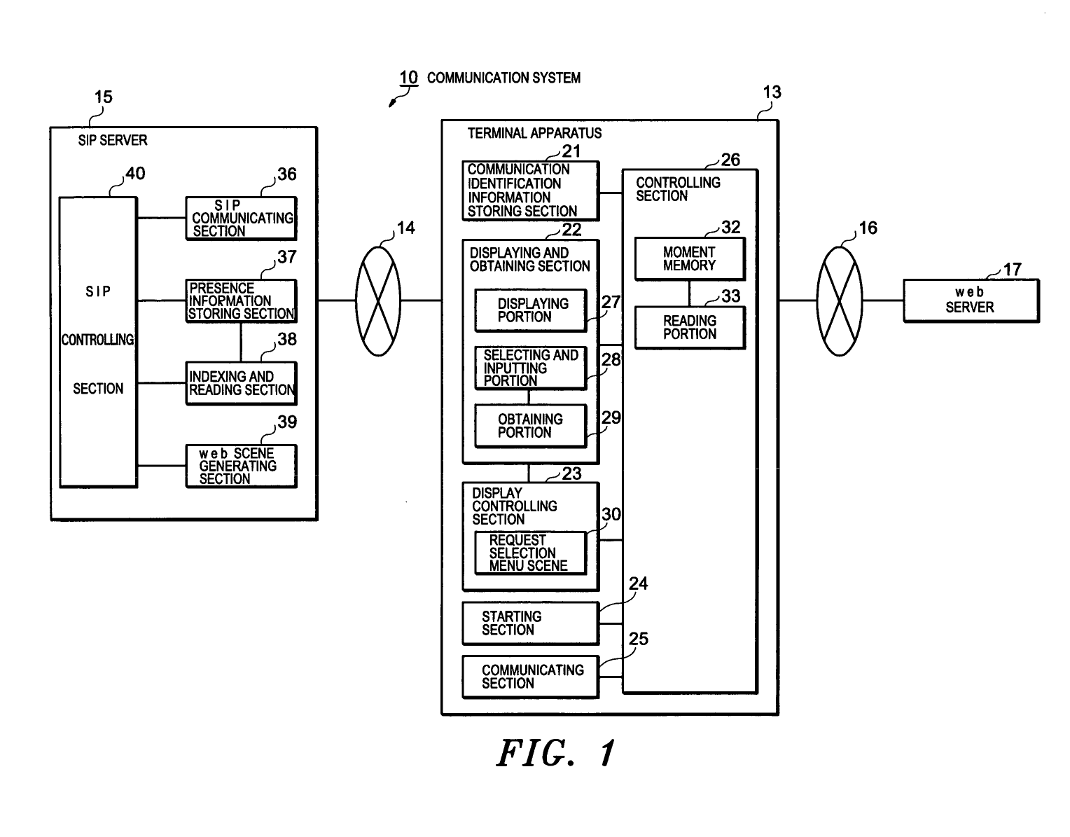

FIG. 1 is a block diagram showing a structure of a part of a communication system in embodiment 1 of the present invention.

The terminal apparatus 13, in the embodiment, is formed from a personal computer having the SIP terminal functioning section 11 and the web terminal functioning section 12, and has communication identification information serving as terminal identification information of the SIP terminal functioning section 11. In the embodiment, the terminal apparatus 13 is set to have a SIP address “zzz999@xxx.yyy.com” as the communication identification information.

Moreover, as the communication identification information, it is also possible to use a telephone number of the SIP terminal functioning section 11 serving as a SIP terminal. In the case, between the SIP terminal functioning section 11 and the SIP server 15, communication is possible via telephone line network.

The terminal apparatus 13, as shown by FIG. 1, in order to realize respective functions of the SIP terminal functioning section 11, includes a communication identification information storing section 21; a displaying and obtaining section 22; a display controlling section 23; a starting section 24; a communicating section 25; and a controlling section 26. The displaying and obtaining section 22, the display controlling section 23, the communicating section 25 and the controlling section 26 constitutes the web terminal functioning section 12.

The communication identification information storing section 21 is an exclusive use storing section to store SIP number or SIP address serving as the communication identification information for specifying the terminal apparatus 13 and performing communication. In the embodiment, the SIP address “zzz999@xxx.yyy.com” is stored. The communication identification information, as communication identification information of the terminal apparatus 13 to perform a request of presence information (mentioned below), that is, as request terminal communication identification information, is used when communicating with the SIP server 15.

The displaying and obtaining section 22 has a displaying portion 27, a selecting and inputting portion 28, and an obtaining portion 29.

The displaying portion 27, for example, is formed from a displayer; as a part of the web terminal functioning section 12, has a browser function to display web scene; or as a part of the SIP terminal functioning section 11, has a function to display a request selection menu scene 30 which is mentioned below and is used for inputting a presence request.

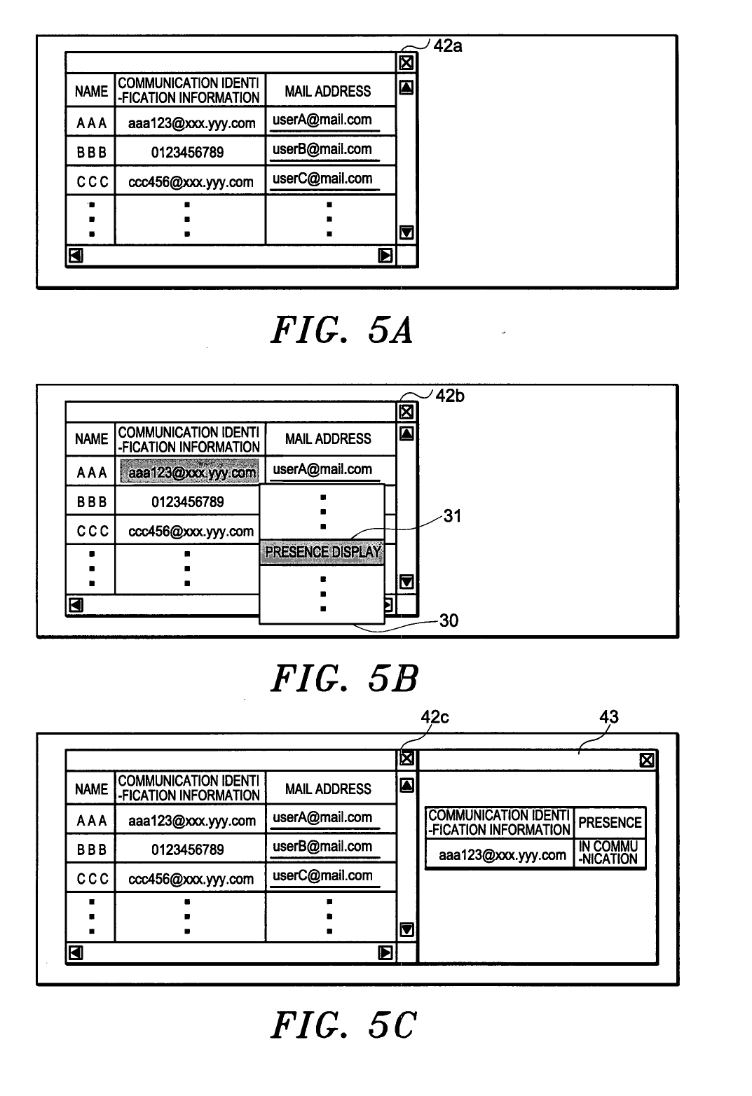

FIG. 5A is an explanation diagram of a first web scene in an example displayed on a displaying section in embodiment 1; FIG. 5B is an explanation diagram of a second web scene in an example displayed on a displaying section in embodiment 1; and FIG. 5C is an explanation diagram of a third web scene in an example displayed on a displaying section in embodiment 1.

The request selection menu scene 30, as shown by FIGS. 5A˜5C, is a menu scene displayed on a web business scene. While the web business scene is displayed for executing web page business, if the user right clicks mouse serving as a selecting and inputting portion 28 mentioned below, respective process menus capable of selecting are displayed. In the request selection menu scene 30, as shown by FIG. 5B, a display request selection button 31 for making the user select a display request of presence information is furnished. Here, because the user is user of the terminal apparatus 13, so it also maybe called “apparatus user”.

The selecting and inputting portion 28 includes a mouse in the embodiment, and is used for making the user select communication identification information stated on web scene displayed on the displaying portion 27, or select selection button furnished on respective scene. Further, the selecting and inputting portion 28, as stated above, has a function serving as an inputting portion to make the user select the display request selection button 31 in the request selection menu scene 30 displayed on the displaying portion 27; and to generate i.e. to input a presence request expressing a display request of presence information. Furthermore, the selecting and inputting portion 28, after generated the presence request, makes a moment memory 32 mentioned below memorize the presence request and notifies the obtaining portion 29 of an input of the presence request.

The obtaining portion 29 has a function that, when notified of the input of the presence request by the selecting and inputting portion 28, obtains communication identification information which is selected by the selecting and inputting portion 28 and serves as communication identification information of confirmation terminal; and sends it to a moment memory 32 mentioned below.

The starting section 24 is storing a communication application program for communicating via the SIP server 15, and has a function to start and execute the communication application program.

The communicating section 25, as a send section, has a function to send the above stated presence request to the SIP server 15; as a part of the SIP terminal functioning section 11, performs communication with the SIP server 15 via the IP network 14; and as a part of the web terminal functioning section 12, performs communication with the web server 17 via the internet 16.

The controlling section 26 includes a moment memory 32 and a reading portion 33.

The moment memory 32 is a memorizing portion to memorize the presence request inputted by the selecting and inputting portion 28, the communication identification information of confirmation terminal obtained by the obtaining portion 29, and the like in a moment.

The reading portion 33 has a function to read out the presence request or the communication identification information of confirmation terminal, that is stored in the moment memory 32.

Further, the controlling section 26 has a function to control respective sections or portions of the above stated terminal apparatus 13.

The SIP server 15 has a function to control communication using SIP signal between the respective SIP terminals 18 and the terminal apparatus 13; and a function to obtain the presence information from the respective SIP terminals 18 and the terminal apparatus 13 and manage the presence information. As shown by FIG. 1, the SIP server 15 includes a SIP communicating section 36, a presence information storing section 37, a indexing and reading section 38, a web scene generating section 39 and a SIP controlling section 40.

The SIP communicating section 36 has a function of server receiving section to receive communication identification information serving as communication identification information of confirmation terminal from the terminal apparatus 13; and a function of server sending section to send web presence scene information mentioned below to the terminal apparatus 13. The SIP communicating section 36 performs communication with the terminal apparatus 13 via the IP network 14.

The presence information storing section 37 is a storing section to store presence information indicating a state of the respective SIP terminals 18 or a state of users of the respective SIP terminals 18.

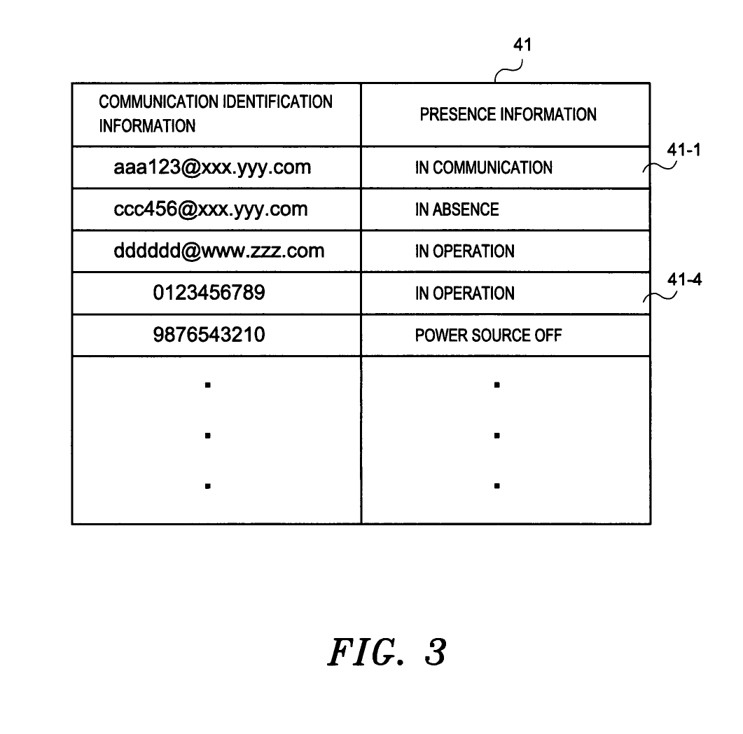

FIG. 3 is an explanation diagram showing a structure of a presence information storing section in embodiment 1.

In the presence information storing section 37, as shown by FIG. 3, a presence information item 41 is provided. In the presence information item 41, to correspond to each SIP terminal 18, i.e. each communication identification information of the respective SIP terminals 18, the respective presence information of the SIP terminals 18 are stored. The presence information stored in the presence information storing section 37, according to a request from the SIP server 15 or a change of presence state of the SIP terminal 18, is rewritten after being sent together with the communication identification information from the SIP terminal 18 to the SIP server 15.

For example, in the presence information storing section 37 shown by FIG. 3, to correspond to a SIP address “aaa123@xxx.yyy.com” as communication identification information, a presence information 41-1 “in communication” to express that the SIP terminal 18 is in communication with another SIP terminal is stored; further, to correspond to a SIP number “0123456789” as communication identification information, a presence information 41-4 “in operation” to express that the user of the SIP terminal 18 is in operation is stored; furthermore, serving as the presence information, “in absence” to express that the user of the SIP terminal 18 is going out or “power source off” to express that the power source of the SIP terminal 18 is turned off or the like is stored. Here, because the user is user of the SIP terminal 18, so it also maybe called “terminal user”.

The indexing and reading section 38 has a function to index the presence information storing section 37 on the basis of the communication identification information; and read out the stored presence information from the presence information item 41.

The web scene generating section 39 generates a web scene for displaying the presence information read out by the indexing and reading section 38, that is, generates web presence scene information being source of web presence scene.

The SIP controlling section 40 has a function to control the above stated respective sections 36˜39.

The web server 17 constitutes a web page business system together with the terminal apparatus 13 having the respective web terminals 19 and the web terminal functioning section 12; and contains respective applications in order to possibly input and refer to various information such as business information, product stock information, schedule information of respective users, address information, and the like in web scene displayed by the respective web terminals 19 and the terminal apparatus 13 in the web page business system. Then, the web server 17, according to the request from the web terminal 19 or the terminal apparatus 13, generates respective web scenes for web page business, i.e. web business scene, and sends the web business scene to the web terminal 19 or the terminal apparatus 13.

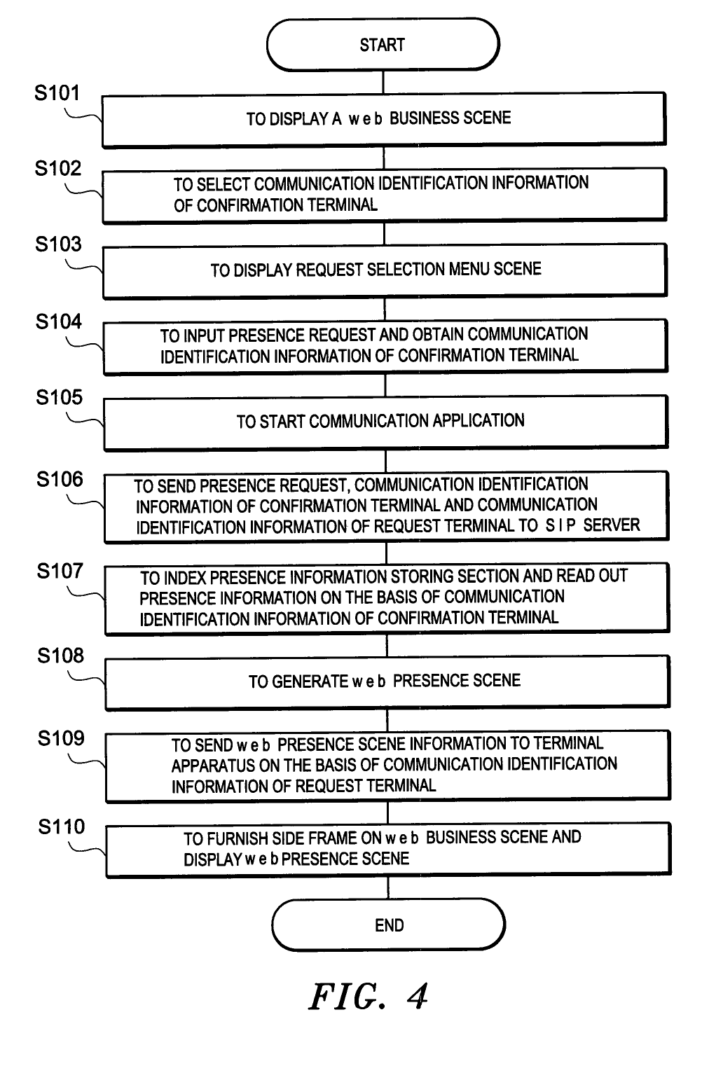

The following is to explain operations of the communication system 10 in the embodiment through referring to FIGS. 4 and 5A˜5C. In the explanation, such case that while a web business is executed in the terminal apparatus 13, the user of the terminal apparatus 13 confirms the presence information corresponding to the SIP terminal 18 is explained as an example.

FIG. 4 is a flowchart to explain operations of a communication system in embodiment 1 of the present invention.

Moreover, in the following explanation, the SIP terminal 18 whose presence information will be confirmed is set to be used by a user whose name is “AAA”, and to have a communication identification information of “aaa123@xxx.yyy.com”.

On the displaying portion 27 of the terminal apparatus 13, through a control of the display controlling section 23, a web business scene 42a (FIG. 5A) which is sent from the web server 17 and is used for web page business is displayed (S101).

On the web business scene 42a, as shown by FIG. 5A, names of respective users i.e. respective terminal users, communication identification information of respective SIP terminals 18 respectively used by the users i.e. are displayed. The user of the terminal apparatus 13, that is, the apparatus user clicks the mouse as the selecting and inputting portion 28 in the web business scene 42a, and selects a communication identification information corresponding to one SIP terminal 18 whose presence information will be confirmed, that is, selects a communication identification information of confirmation terminal. After selection, the apparatus user performs a right click. In the web business scene 42a, the name “AAA” serving as the communication identification information of confirmation terminal and corresponding to the SIP terminal 18 whose SIP address is “aaa123@xxx.yyy.com” is selected. Thereby, the selecting and inputting portion 28 selects the communication identification information of confirmation terminal on the basis of the operations of the apparatus user (S102).

Then, the display controlling section 23 accepts the selection operation of the selecting and inputting portion 28, reads out a request selection menu scene 30 and makes the displaying portion 27 display it (S103). Then, on the displaying portion 27, as shown by FIG. 5B, together with the web business scene 42b, the request selection menu scene 30 containing respective process menus capable of selecting is displayed.

when the apparatus user operated the mouse as the selecting and inputting portion 28 and presses a display request selection button 31 in the request selection menu scene 30 for selecting a display request of presence information, the selecting and inputting portion 28 generates a presence request and makes the moment memory 32 memorize the presence request (S104). Further, the selecting and inputting portion 28 notifies the obtaining portion 29 of an input of the presence request. The obtaining portion 29 received the notification obtains the communication identification information of confirmation terminal “aaa123@xxx.yyy.com” selected in the web business scene 42b,and makes the moment memory 32 memorize the communication identification information of confirmation terminal (S104).

Continuously, the controlling section 26 received the input of the presence request controls the starting section 24 to start communication application (S105). The terminal apparatus 13 executes the communication application and becomes a state capable of communicating via the SIP server 15.

Then, the reading portion 33 reads out the presence request and the communication identification information of confirmation terminal “aaa123@xxx.yyy.com” from the moment memory 32, and reads out the communication identification information of the terminal apparatus 13 from the communication identification information storing section 21, that is, the communication identification information of request terminal “zzz999@xxx.yyy.com”. Continuously, the communicating section 25 sends the presence request, the communication identification information of confirmation terminal “aaa123@xxx.yyy.com” and the communication identification information of request terminal “zzz999@xxx.yyy.com” that are read out by the reading portion 33 to the SIP server 15 (106).

In the SIP server 15, when the SIP communicating section 36 received the presence request, the communication identification information of confirmation terminal “aaa123@xxx.yyy.com” and the communication identification information of request terminal “zzz999@xxx.yyy.com” from the terminal apparatus 13, the SIP controlling section 40 makes a not shown moment memory memorize the presence request, the communication identification information of confirmation terminal and the communication identification information of request terminal.

Continuously, the SIP controlling section 40 controls the indexing and reading section 38 to index the presence information storing section 37 on the basis of the received communication identification information of confirmation terminal “aaa123@xxx.yyy.com” and to read out the stored presence information from the corresponding presence information item 41 (S107). The indexing and reading section 38 reads out the presence information 41-1 “in communication” and send it to the not shown moment memory.

Then, the web scene generating section 39 reads out the communication identification information of confirmation terminal and the presence information from the moment memory, and generates a web presence scene on the basis of the read out information (S108). An example of the generated web presence scene is shown by FIG. 5C. The web scene generating section 39 previously stores a form of HTML (Hyper Text Markup Language) source of the web presence scene, through setting the communication identification information of confirmation terminal that are read out from the moment memory and the presence information to predetermined areas of the form, generates the HTML source of a web presence scene 43 as web presence scene information.

Then, the SIP communicating section 36 sends the web presence scene information generated by the web scene generating section 39 to the terminal apparatus 13 on the basis of the SIP address “zzz999@xxx.yyy.com” as the communication identification information of request terminal stored in the moment memory (S109).

In the terminal apparatus 13, when the communicating section 25 received the web presence scene information from the SIP server 15, the display controlling section 23 furnishes a side frame in web business scene 42c displayed by the displaying portion 27, and displays the web presence scene 43 in the side frame on the basis of the received web presence scene information (S110).

The web business scene 42c and the web presence scene 43 displayed by the displaying portion 27 are shown by FIG. 5C. Because the web presence scene 43 is displayed in the side frame of the web business scene 42c, the apparatus user of the terminal apparatus 13 can confirm the desired presence information without changing display scene, further can continues to execute web business in the web business scene 42c while looking at the web presence scene 43. For example, when the SIP terminal 18 with the communication identification information “aaa123@xxx.yyy.com” is confirmed being in communication, the apparatus user can click the email address “userA@mail.com” of the SIP terminal 18, which is displayed on the web business scene 42c by using mouse, and send an email. Thereby, it is possible to save a lot of time for useless communication and to effectively execute web business.

As stated above, because the communication system of the embodiment can use the existing web server just as it is, and can display the desired presence information on web scene, so it is possible to reduce the time and cost for developing the system, further, it is possible to easily realize an addition of new function with respect to the web page business system.

Moreover, in the embodiment, as a terminal apparatus, a personal computer with SIP terminal function and web terminal function is used, instead of it, a portable information terminal (i.e. PDA) with SIP terminal function and web terminal function also can be used.

Further, as the terminal apparatus, a portable telephone apparatus with web terminal function also can be used. In the case, as the terminal identification information, the telephone number of the portable telephone apparatus can be used.

Furthermore, a terminal system formed from a telephone apparatus with SIP terminal function and a personal computer with web terminal function also can be used. In the case, the communication between the SIP server and the telephone apparatus is performed via telephone line network; as the terminal identification information, the telephone number of the telephone apparatus can be used. Further, instead of the personal computer in the terminal system, the portable information terminal (i.e. PDA) with web terminal function can be used.

Moreover, in the embodiment, as the communication identification information i.e. terminal identification information used for communication via SIP server, the SIP address and the SIP number are used, however, the present invention is not limited by these. As the terminal identification information, it is also possible to use information capable of specifying communication terminal in SIP server, for example, user name of the terminal user, email address or the like. In the case, the presence information storing section stores the presence information to correspond to the terminal identification information; the indexing and reading section executes an indexing and reading process of the presence information on the basis of the terminal identification information. In the case to use email address as the terminal identification information, regarding the structure and the operations of the communication system, they will be explained in embodiment 2 in detail.

### Embodiment 2

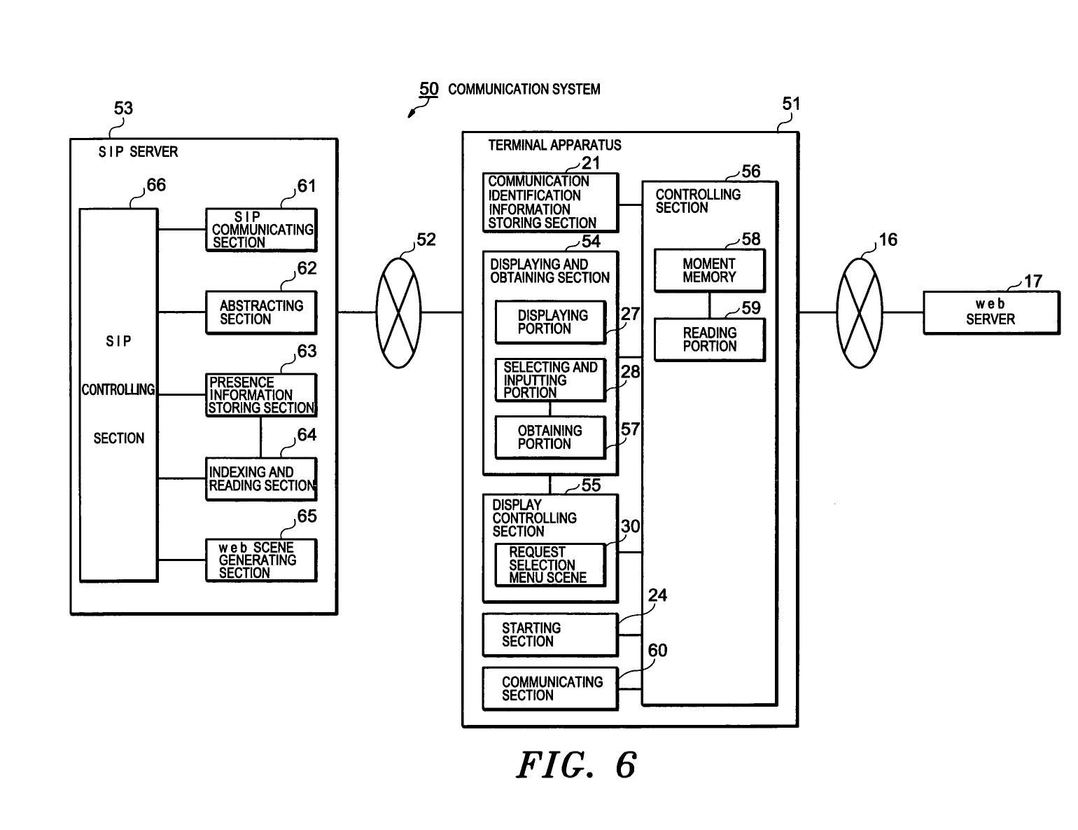

FIG. 6 is a block diagram showing a structure of a part of a communication system in embodiment 2 of the present invention.

A communication system 50 of the present invention, as shown by FIG. 6, comprises a terminal apparatus 51 including a SIP terminal function and a web terminal function; a SIP server 53 capable of communicating with the terminal apparatus 51 via an IP network 52; a web server 17 capable of communicating with the terminal apparatus 51 via an internet 16.

Moreover, in the embodiment, regarding the same composition as that in the embodiment 1, the same symbol will be assigned to it; and regarding the same function and operation as that in the embodiment 1, it's explanation will be omitted.

The terminal apparatus 51 includes a communication identification information storing section 21; a displaying and obtaining section 54; a display controlling section 55; a starting section 24; a communicating section 60; and a controlling section 56.

The displaying and obtaining section 54 has a displaying portion 27, a selecting and inputting portion 28, and an obtaining portion 57.

The obtaining portion 57 obtains web scene displayed by the displaying portion 27, that is, obtains web scene information of web business scene. In the embodiment, the web scene information obtained by the obtaining portion 57 is formed from HTML source of web scene.

The display controlling section 55 controls the displaying and obtaining operations of the displaying and obtaining section 54.

The communicating section 60, as a send section, has a function to send presence request or web scene information to the SIP server 53; performs communication with the SIP server 53 via the IP network 52; and performs communication with the web server 17 via the internet 16.

The controlling section 56 includes a moment memory 58 and a reading portion 59, and has a function to control the above stated respective sections or portions.

The moment memory 58 memorizes presence request inputted by the selecting and inputting portion 28, web scene information obtained by the obtaining portion 57, and the like in a moment.

The reading portion 59 has a function to read out the presence request or the web scene information that is stored in the moment memory 58.

The SIP server 53, as shown by FIG. 6, includes a SIP communicating section 61, an abstracting section 62, a presence information storing section 63, a indexing and reading section 64, a web scene generating section 65 and a SIP controlling section 66 for controlling these respective sections.

The SIP communicating section 61 has a function serving as a server receiving section to receive web scene information from the terminal apparatus 51; and a function serving as a server sending section to send web presence scene information to the terminal apparatus 51. The SIP communicating section 61 performs communication with the terminal apparatus 51 via the IP network 52.

The abstracting section 62 abstracts terminal identification information serving as communication identification information from the web scene information received by the SIP communicating section 61.

The presence information storing section 63 is a storing section to store presence information of respective SIP terminals 18 or users of the respective SIP terminals 18 to correspond to the respective terminal identification information of the SIP terminals 18.

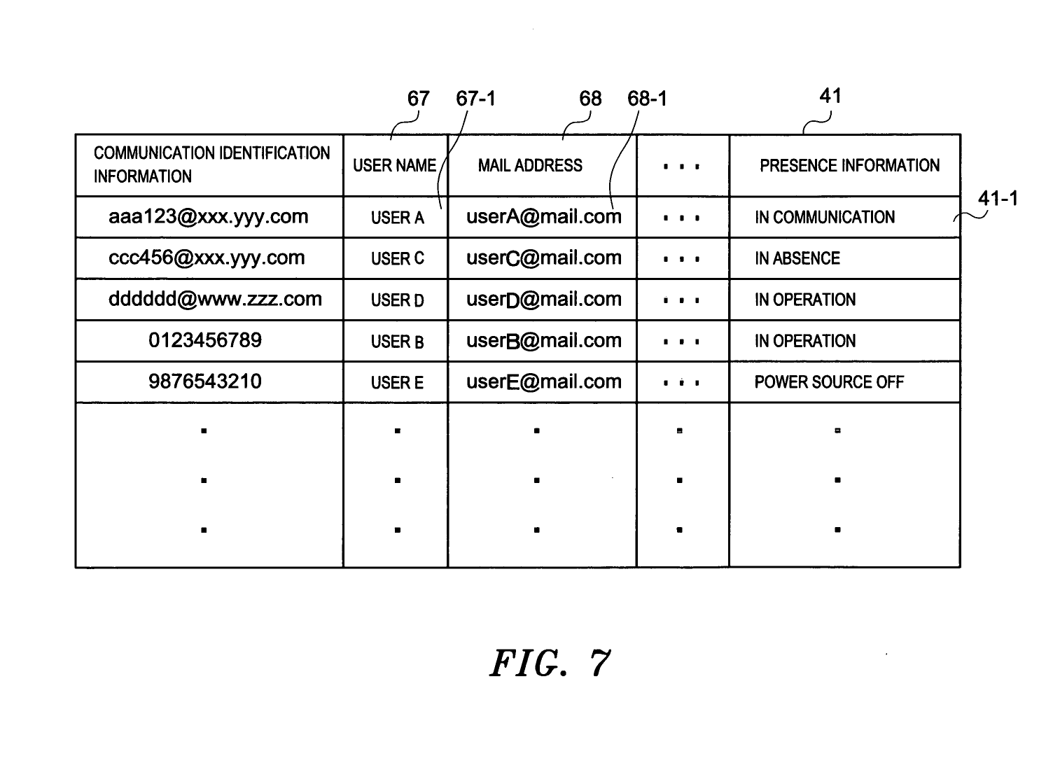

FIG. 7 is an explanation diagram showing a structure of a presence information storing section in embodiment 2.

In the presence information storing section 63, as shown by FIG. 7, a presence information item 41 is provided. In the presence information item 41, to correspond to each SIP terminal 18, i.e. each terminal identification information of the respective SIP terminals 18, the respective presence information of the SIP terminals 18 are stored.

The terminal identification information stored in the presence information storing section 63, in the embodiment, not only contains communication identification information, but also contains user identification information consisting of user name and email address. In the presence information storing section 63, a user name item 67 and a mail address item 68 are furnished, then, the user name of the terminal user and the email address of the SIP terminal 18 are stored as terminal identification information of the SIP terminal 18.

For example, in the presence information storing section 63 shown by FIG. 7, to correspond to a SIP address “aaa123@xxx.yyy.com” as communication identification information, a user name 67-1 “user A” and a mail address 68-1 “userA@mail.com” are stored. Then, to correspond to them, a presence information 41-1 “in operation” is stored.

Moreover, as the terminal identification information, in the embodiment, the communication identification information and the user identification information are used. However, the present invention is not limited by these. Other identification information capable of specifying the SIP terminal 18 can be used as the terminal identification information.

The indexing and reading section 64 has a function to index the presence information storing section 63 on the basis of the terminal identification information abstracted by the abstracting section 62, and read out the presence information from the presence information item 41.

The web scene generating section 65 generates a web presence scene information of web presence scene on the basis of the presence information read out by the indexing and reading section 64 and of the web scene information received by the SIP communicating section 61.

The SIP controlling section 66 has a function to control the above stated respective sections.

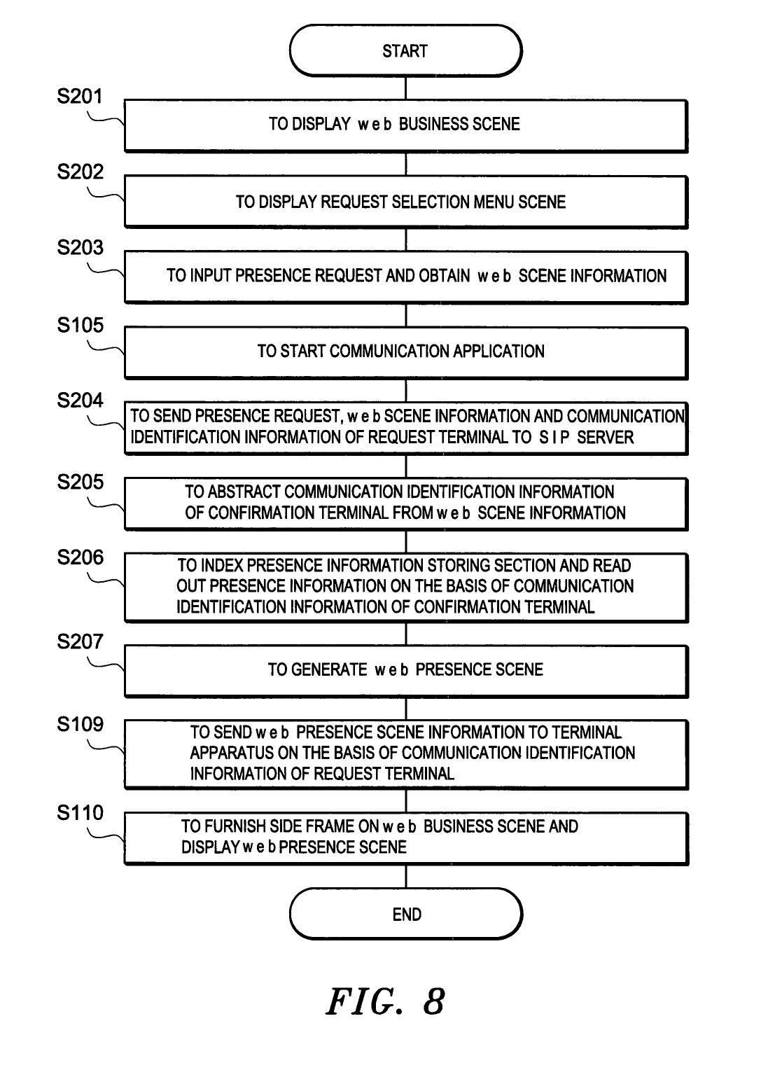

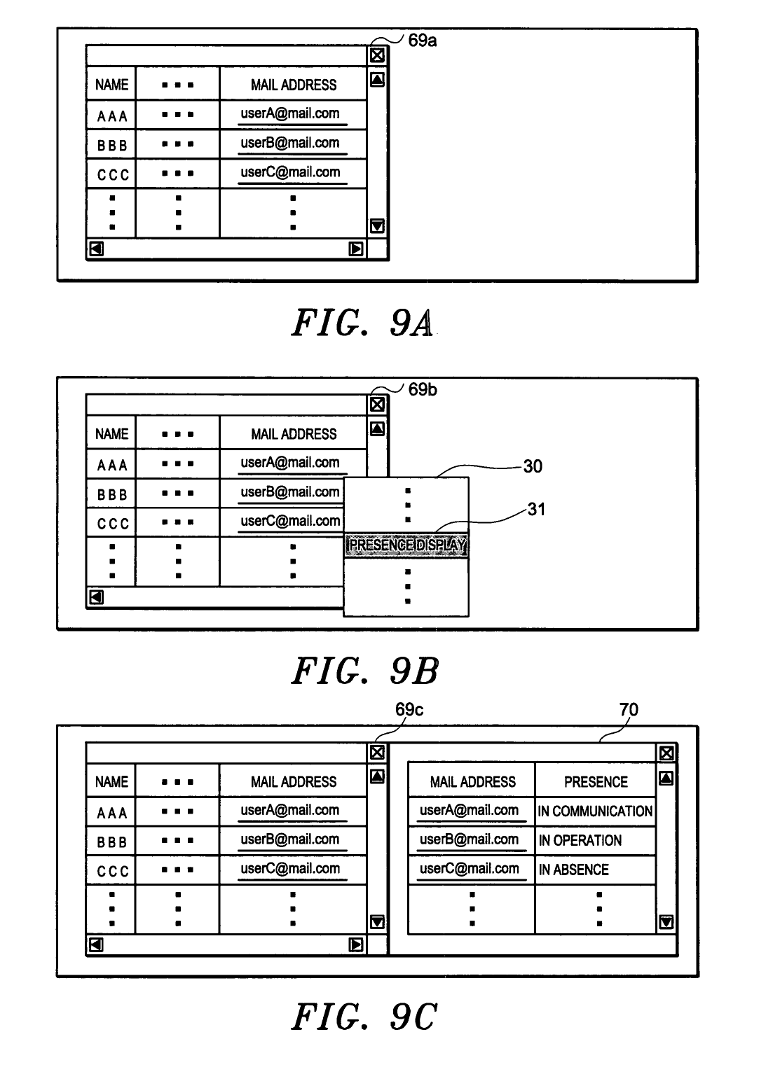

The following is to explain operations of the communication system 50 in the embodiment 2 through referring to FIGS. 8 and 9.

FIG. 8 is a flowchart to explain operations of a communication system in embodiment 2 of the present invention; FIG. 9A is an explanation diagram of a first web scene in an example displayed on a displaying section in embodiment 2; FIG. 9B is an explanation diagram of a second web scene in an example displayed on a displaying section in embodiment 2; and FIG. 9C is an explanation diagram of a third web scene in an example displayed on a displaying section in embodiment 2.

On the displaying portion 27 of the terminal apparatus 51, through a control of the display controlling section 55, a web business scene 69a (FIG. 9A) which is sent from the web server 17 and is used for web page business is displayed (S201).

On the web business scene 69a, as shown by FIG. 9A, names of respective terminal users, email address and the like are displayed. However, the communication identification information of the SIP terminal 18 used by the terminal user is not displayed.

The apparatus user of the terminal apparatus 51 operates the mouse as the selecting and inputting portion 28 in the web business scene 69a and performs a right click. The display controlling section 55 detects the selection operation of the selecting and inputting portion 28, reads out a request selection menu scene 30 and makes the displaying portion 27 display it (S202). Then, on the displaying portion 27, as shown by FIG. 9B, a web business scene 69b and the request selection menu scene 30 are displayed.

when the apparatus user operated the mouse as the selecting and inputting portion 28 and presses a display request selection button 31 in the request selection menu scene 30 for selecting a display request of presence information, the selecting and inputting portion 28 generates a presence request and makes the moment memory 32 memorize the presence request (S203). Further, the selecting and inputting portion 28 notifies the obtaining portion 57 of an input of the presence request. The obtaining portion 57 received the notification obtains HTML source of the web business scene 69, that is, web scene information, and makes the moment memory 32 memorize the web scene information (S203).

Continuously, the controlling section 56 received the input of the presence request controls the starting section 24 to start communication application (S105).

Then, the reading portion 59 reads out the presence request and the web scene information from the moment memory 58; and reads out the communication identification information of terminal apparatus 51, that is, the communication identification information of request terminal from the communication identification information storing section 21. Continuously, the communicating section 60 sends the presence request, the web scene information and the communication identification information of request terminal that are read out by the reading portion 59 to the SIP server 53 (204).

In the SIP server 53, when the SIP communicating section 61 received the presence request, the web scene information and the communication identification information of request terminal from the terminal apparatus 51, the SIP controlling section 66 makes a not shown moment memory memorize the presence request, the web scene information and the communication identification information of request terminal.

Continuously, the SIP controlling section 66 controls the abstracting section 62 to abstract the terminal identification information from the received web scene information (S205).then, the abstracting section 62 abstracts the terminal identification information contained in the web scene information, as communication identification information of confirmation terminal.

The abstraction of the terminal identification information by the abstracting section 62, for example, is executed as follows. That is, the abstracting section 62 indexes letter string “sip:” indicating link of SIP address in the web scene information i.e. the HTML source of the web business scene 69. Then, when the letter string “sip:” is detected, the abstracting section 62 abstracts a letter string which is following the letter string “sip:” and is stated in the HTML source, as SIP address, i.e. as communication identification information. In the same way, the abstracting section 62 indexes a letter string “tel:”, when the letter string “tel:” is detected, abstracts a letter string which is following the letter string “tel:” and is stated in the HTML source, as SIP number i.e. as communication identification information. Further, the abstracting section 62 indexes a letter string “mailto:”, when the letter string “mailto:” is detected, abstracts a letter string which is following the letter string “mailto:” and is stated in the HTML source, as email address i.e. as terminal identification information.

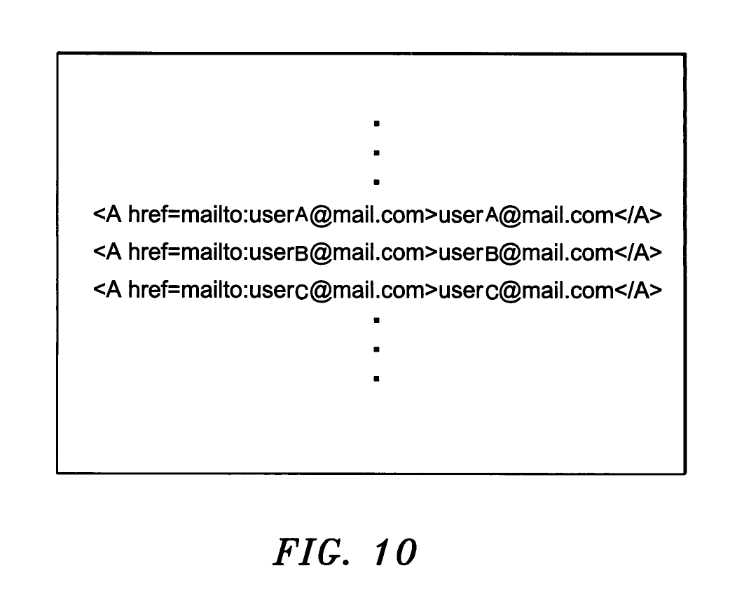

FIG. 10 is an explanation diagram showing an example of web scene information.

In the web scene information i.e. HTML source obtained from the web business scene 69 (FIGS. 9A˜9C), as shown by FIG. 10, a letter string “mailto:” is plurally contained. The abstracting section 62, after detected the letter string “mailto:” further indexes a part “>” of HTML tag stated behind the letter string “mailto:”. Then, when the “>” is detected, the letter strings “userA@mail.com”, “userB@mail.com”, “userCmail.com” stated between the “mailto:” and the “>” are respectively abstracted as communication identification information of confirmation terminal.

When the communication identification information of confirmation terminal is abstracted (S205) as stated above, the SIP controlling section 66 controls the indexing and reading section 64 to index the presence information storing section 63 on the basis of the communication identification information of confirmation terminal (S206). The indexing and reading section 64 reads out the stored presence information 41-1 “in communication” which corresponds to the abstracted communication identification information of confirmation terminal “userA@mail.com”. In the same way, the indexing and reading section 64 also reads out the presence information “in operation” and “in absence” respectively corresponding to the communication identification information of confirmation terminal “userB@mail.com” and “userC@mail.com”.

Then, the web scene generating section 65 generates a web presence scene (S207). The web scene generating section 65 reads out the web scene information memorized in the moment memory and generates web presence scene information being source of web presence scene. That is, in order to display the communication identification information of confirmation terminal abstracted from the web scene information and the corresponding respective presence information read out by the indexing and reading section 64 in the same form as the web business scene 69, the web scene generating section 65 generates the HTML source of web presence scene 70, as web presence scene information.

Then, the SIP communicating section 61 sends the web presence scene information generated by the web scene generating section 65 to the terminal apparatus 51 on the basis of the communication identification information of request terminal, stored in the moment memory (S110).

In the terminal apparatus 51, when the communicating section 60 received the web presence scene information from the SIP server 53, the display controlling section 55 furnishes a side frame in web business scene 69c, and displays the web presence scene 70 in the side frame on the basis of the received web presence scene information (S110).

The web business scene 69c and the web presence scene 70 displayed by the displaying portion 27 are shown by FIG. 9C. Because the presence information of the respective SIP terminals 18 are displayed according to the display order in web business scene 69 in the web presence scene 70, so the apparatus user does not need to perform troublesome operation such as index or change of display scene or the like.

As stated above, because the communication system of the embodiment abstracts the terminal identification information from the web scene information of the web business scene and performs a display of the corresponding presence information, so it is possible to further effectively execute web business. Further, through storing the terminal identification information such as user identification information and the like into the presence information storing section, even if the web business scene does not contain communication identification information, it is also possible to display the presence information of the respective terminals.

Moreover, in the embodiment, as a terminal apparatus, a personal computer with SIP terminal function and web terminal function is used, instead of it, a portable information terminal (i.e. PDA) with SIP terminal function and web terminal function also can be used.

Further, as the terminal apparatus, a portable telephone apparatus with web terminal function also can be used. In the case, as the terminal identification information, the telephone number of the portable telephone apparatus can be used.

Furthermore, a terminal system formed from a telephone apparatus with SIP terminal function and a personal computer with web terminal function also can be used. In the case, the communication between the SIP server and the telephone apparatus is performed via telephone line network; as the terminal identification information, the telephone number of the telephone apparatus can be used. Further, instead of the personal computer in the terminal system, the portable information terminal (i.e. PDA) with web terminal function can be used.

The present invention is not limited to the foregoing embodiments but many modifications and variations are possible within the spirit and scope of the appended claims of the invention.

What is claimed is:

1. A communication system, comprising:
a web server which stores web scene;
a terminal apparatus which enables to communicate with said web server;
a plurality of communication terminals each has terminal identification information; and
a communication server which has a presence information storing section which enables to communicate with said terminal apparatus and said communication terminal, and stores presence information indicating a state of said communication terminal or a state of user of said communication terminal to correspond to said terminal identification information of said communication terminal,
wherein said web server has web scene in which said terminal identification information is stated;
said terminal apparatus includes a displaying and obtaining section which displays said web scene and obtains said displayed terminal identification information, an inputting section which inputs a presence request expressing to request said presence information corresponding to said obtained terminal identification information, and a sending section which sends said inputted presence request and said obtained terminal identification information to said communication server;
said communication server includes a server receiving section to receive said presence request and said terminal identification information from said terminal apparatus, an indexing and reading section which indexes said presence information storing section on the basis of said received terminal identification information and reads out said corresponding presence information, a web scene generating section which generates a web scene serving as web presence scene for displaying said presence information read out, and a server sending section which send web presence scene information of said web presence scene to said terminal apparatus.

2. The communication system according to claim 1,
wherein said terminal apparatus further includes a starting section which starts communication application for requesting said presence information with respect to said communication server, together with an input of said inputting section,
said sending section performs a sending operation together with a start of said starting section.

3. The communication system according to claim 1,
wherein said displaying and obtaining section further displays said web presence scene together with said web scene, on the basis of said web presence scene information received from said communication server.

4. The communication system according to claim 1,
wherein said terminal apparatus further includes a display controlling section which makes said displaying and obtaining section display a request selection menu scene for making user of said terminal apparatus select whether to request said presence information or not,
said inputting section performs an input of said presence request on the basis of a request selection.

5. The communication system according to claim 1,
wherein said displaying and obtaining section obtains web scene information of said displayed web scene;
said sending section further sends said obtained web scene information to said communication server;
said communication server further includes an abstracting section which abstracts said terminal identification information from said web scene information received from said terminal apparatus; and
said indexing and reading section performs an indexing and reading operation on the basis of said abstracted terminal identification information.

6. The communication system according to claim 5,
wherein said web scene information is formed from HMTL source of said web scene.

7. The communication system according to claim 1,
wherein said web presence scene information is formed from HMTL source of said web presence scene.

8. The communication system according to claim 1,
wherein said terminal identification information is communication number of said communication terminal, which is formed from plural numerals.

9. The communication system according to claim 1,
wherein said terminal identification information is communication address of said communication terminal, which is formed from plural English letters and symbols.

10. The communication system according to claim 1,
wherein said terminal identification information is email address of said communication terminal.

11. The communication system according to claim 1,
wherein said terminal identification information is user name of user of said communication terminal.

12. The communication system according to claim 1,
wherein said communication server is a SIP server executing communication by using SIP signal, said terminal apparatus and communication terminal is a personal computer capable of respectively communicating with said SIP server via IP network, said terminal identification information is SIP address of said personal computer.

13. The communication system according to claim 1,
wherein said communication server is a SIP server executing communication by using SIP signal, said terminal apparatus and communication terminal is a portable telephone apparatus capable of respectively communicating with said SIP server via IP network, said terminal identification information is telephone number of said portable telephone apparatus.

14. The communication system according to claim 1,
wherein said communication server is a SIP server executing communication by using SIP signal, said terminal apparatus and communication terminal is a portable information terminal (PDA) capable of respectively communicating with said SIP server via IP network, said terminal identification information is SIP address of said portable information terminal.

15. The communication system according to claim 1,
wherein said communication server is a SIP server executing communication by using SIP signal, said communication terminal is a telephone apparatus capable of communicating with said SIP server via telephone line network, said terminal identification information is telephone number of said telephone apparatus.

16. The communication system according to claim 1,
wherein said communication server is a SIP server executing communication by using SIP signal, said terminal apparatus consists of a telephone apparatus capable of communicating with said SIP server via telephone line network and a communication terminal capable of communicating with said web server via internet.
